(19) United States
(12) Patent Application Publication
(10) Pub. No.: US 2026/0357370 A1
(43) Pub. Date: Nov. 12, 2026

(54) METHOD FOR SEPARATING A METAL MIXTURE USING A ROTARY REACTOR, AND A REACTION SYSTEM FOR SEPARATING A METAL MIXTURE USING A ROTARY REACTOR

(71) Applicants: INSTITUTE FOR BASIC SCIENCE, Daejeon (KR); ULSAN NATIONAL INSTITUTE OF SCIENCE AND TECHNOLOGY, Ulsan (KR)

(72) Inventors: Bartorz GRZYBOWSKI, Ulsan (KR); Olgierd CYBULSKI, Ulsan (KR); Cristobal QUINTANA, Ulsan (KR)

(21) Appl. No.: 19/130,781

(22) PCT Filed: Nov. 17, 2023
(86) PCT No.: PCT/KR2023/018556

§ 371 Date: May 16, 2025

(30) Foreign Application Priority Data
Nov. 17, 2022 (KR) 10-2022-0154743
Oct. 27, 2023 (KR) 10-2023-0145901

(51) Int. Cl. C22B 3/02; C22B 3/00; C22B 3/38; C22B 3/40; C22B 7/00; C22B 26/12; C22B 47/00; H01M 10/54

(52) U.S. Cl. CPC C22B 3/02; C22B 3/3844; C22B 3/408; C22B 7/007; C22B 23/043; C22B 23/0453; C22B 26/12; C22B 47/00; H01M 10/54

(57) ABSTRACT

The present invention relates to a method for selectively separating a specific metal from a leach solution containing a metal mixture using a rotary reactor, the method comprising: a) in the reactor which is rotating, forming an aqueous feed phase which contains the leach solution containing the metal mixture, an organic phase which includes one or more organic extractants for selectively extracting the specific metal from the aqueous feed phase and is formed adjacent to the aqueous feed phase, and an aqueous acceptor phase which is formed adjacent to the organic phase, in the form of concentric layers, respectively; and b) transferring the specific metal in the aqueous feed phase to the aqueous acceptor phase by the organic extractant included in the organic phase and acting as a molecular shuttle between an aqueous feed phase/organic phase interface and an organic phase/aqueous acceptor phase interface.

### TECHNICAL FIELD

The present invention relates to a method for selectively separating a specific metal from a leach solution containing a metal mixture using a rotary reactor.

In addition, the present invention relates to a reaction system for selectively separating a specific metal from a leach solution containing a metal mixture using a rotary reactor.

### BACKGROUND ART

The present applicant has published a reaction method for forming a laminate structure of liquid concentric layers which are immiscible in a rotary reactor, and a reaction system which includes immiscible liquid concentric layers formed in the rotary reactor, in accordance with Related Patent Document 1 and Related Non-Patent Document 1. According to Related Patent Document 1 and Related Non-Patent Document 1, an advantage of being able to apply deformation such as extraction or addition of an immiscible material to a specific concentric layer without damaging the entire laminate structure of the liquid concentric layers is confirmed, and also, an advantage of being able to proceed with a multi-step reaction efficiently in terms of time and space is confirmed.

Meanwhile, a lithium ion battery, which is a type of battery capable of charging and discharging, is widely used in portable electronic devices, electric vehicles, grid energy storage devices, and the like due to its high energy density, and its demand is expected to increase further in the future.

Accordingly, considering environmental and safety issues resulting from increasing lithium ion battery wastes, interest is also gathering in a technology of extracting valuable metal such as cobalt and manganese from waste lithium ion batteries and recycling the metal.

However, upon review of conventional technologies for recycling valuable metal of the waste lithium ion batteries, they are generally complicated and costly. In particular, in the conventional technologies using a plurality of reactors, since reaction conditions should be finely adjusted in each reactor, a recycling process is complicated overall, and thus, process costs may be greatly increased. In addition, in the conventional technologies using a separator in the reactor, the separator may become unstable by strong stirring of the reactor.

Accordingly, a new technology which is provided with an economical and stable form as compared with the conventional technologies and also may achieve a high extraction speed for valuable metals of the waste lithium ion battery is demanded.

### RELATED ART DOCUMENTS

### Patent Document

1. Korean Patent Laid-Open Publication No. KR 10-2020-0091358 A

### Non-Patent Documents

1. Cybulski, O. et al. Concentric liquid reactors for chemical synthesis and separation. Nature 586, 57-63 (2020).
2. Kim, K., Raymond, D., Candeago, R. & Su, X. Selective cobalt and nickel electrodeposition for lithium-ion battery recycling through integrated electrolyte and interface control. Nat. Commun. 12, 1-10 (2021).
3. Chagnes, A. & Pospiech, B. A brief review on hydrometallurgical technologies for recycling spent lithium-ion batteries. J. Chem. Technol. Biotechnol. 88, 1191-1199 (2013).

### DISCLOSURE

### Technical Problem

An object of the present invention is to provide a base for efficiently separating a specific metal in terms of time and space, through a specific method and a reaction system which selectively separate the specific metal from a leach solution containing a metal mixture using a rotary reactor.

In particular, an object of the present invention is to provide a base for efficiently separating a specific valuable metal in terms of time and space, through a specific method and a reaction system which selectively separate the specific precious metal from a leach solution of a waste lithium ion battery containing a metal mixture using a rotary reactor.

### Technical Solution

In one general aspect, a method for selectively separating a specific metal from a leach solution containing a metal mixture using a rotary reactor includes:
a) in the reactor which is rotating, forming an aqueous feed phase which contains the leach solution containing the metal mixture, an organic phase which includes one or more organic extractants for selectively extracting the specific metal from the aqueous feed phase and is formed adjacent to the aqueous feed phase, and an aqueous acceptor phase which is formed adjacent to the organic phase, in the form of concentric layers, respectively; and
b) transferring the specific metal in the aqueous feed phase to the aqueous acceptor phase by the organic extractant included in the organic phase and acting as a molecular shuttle between an aqueous feed phase/organic phase interface and an organic phase/aqueous acceptor phase interface,
wherein the aqueous acceptor phase has a higher density than the organic phase,
the aqueous feed phase and the aqueous acceptor phase are not formed adjacent to each other, and
the aqueous feed phase has a higher pH than the aqueous acceptor phase.

In another general aspect, a reaction system for selectively separating a specific metal from a leach solution containing a metal mixture using a rotary reactor is provided, wherein
in the reactor which is rotating, an aqueous feed phase which contains the leach solution containing the metal mixture, an organic phase which includes one or more organic extractants for selectively extracting the specific metal from the aqueous feed phase and is formed adjacent to the aqueous feed phase, and an aqueous acceptor phase which is formed adjacent to the organic phase are formed in the form of concentric layers, respectively,
the specific metal in the aqueous feed phase is transferred to the aqueous acceptor phase by the organic extractant included in the organic phase and acting as a molecular shuttle between an aqueous feed phase/organic phase interface and an organic phase/aqueous acceptor phase interface,
the aqueous acceptor phase has a higher density than the organic phase,
the aqueous feed phase and the aqueous acceptor phase are not formed adjacent to each other, and
the aqueous feed phase has a higher pH than the aqueous acceptor phase.

### Advantageous Effects

The method and the reaction system of the present invention using a rotary reactor are for selectively separating a specific metal from a leach solution containing a metal mixture and may efficiently separate the specific metal in terms of time and space.

Specifically, according to the method and the reaction system of the present invention, even in the case of using a low concentration extractant for the leach solution containing a metal mixture, an excellent separation speed may be secured and also high selectivity to a subject to be separated may be secured. In addition, since the method and the reaction system of the present invention use one reactor and do not have a separate separator mounted in the reactor, they are provided with an economical and stable form as compared with conventional technologies for selective separation of the metal mixture.

More specifically, in the selective separation of the specific precious metal from the leach solution of a waste lithium ion battery, the method and the reaction system of the present invention are very effective. First, for the leach solution of the waste lithium ion battery, an excellent separation speed may be achieved even in the case of using an extractant having a much lower concentration than that of the conventional related technologies. In particular, according to the specific embodiments of the method and the reaction system of the present invention, an unprecedentedly high separation speed for the leach solution may also be achieved.

### DESCRIPTION OF DRAWINGS

FIG. 1 relates to a non-limiting example of a specific first embodiment of the method of the present invention and shows a cross-sectional view ((a)) and an essential plan view ((b)) for illustrating a rotary reactor and a laminate structure of liquid concentric layers.

FIG. 2A shows a non-stirring mode of a specific second embodiment of the method of the present invention. FIG. 2B is a side view (along a rotation axis) of the rotary reactor by the non-stirring mode of FIG. 2A. FIG. 2C shows a mechanism of a stirring mode of the specific second embodiment of the method of the present invention.

FIG. 3A shows an example of the rotary reactor used in the specific second embodiment of the method of the present invention. FIG. 3B shows the structure and the form of an example of a cylindrical reactor included in the rotary reactor of the specific second embodiment of the method of the present invention. FIG. 3C shows the structure and the form of an example of an internal rotor included in the rotary reactor of the specific second embodiment of the method of the present invention.

FIGS. 4A and 4B are reaction schematic diagrams of Example 1 of the present invention. FIG. 4C is a metal distribution diagram of an aqueous feed phase before a shuttling treatment of Example 1, and also is a metal distribution diagram of each shuttled liquid phase.

FIG. 5 is a reaction schematic diagram of Example 3 of the present invention.

### BEST MODE

Hereinafter, the present invention will be described in detail with reference to accompanying drawings. The present invention may be variously modified and have several forms. Therefore, specific exemplary embodiments of the present invention will be illustrated in the accompanying drawings and be described in detail in the present specification. However, it is to be understood that the present invention is not limited to a specific disclosed form, but includes all of the modifications, equivalents, and substitutions within the spirit and technical scope of the present invention.

Unless otherwise defined, all terms used herein including technical or scientific terms have the same meanings as those commonly understood by a person with ordinary skill in the art to which the present invention pertains. The terms such as those defined in a commonly used dictionary should be interpreted as having the meaning which matches the meaning in the context of the related art, and unless otherwise clearly defined in the present invention, the terms should not be interpreted as having ideal or excessively formal meanings.

Throughout the present specification, unless explicitly described to the contrary, “comprising” any elements will be understood to imply further inclusion of other elements rather than the exclusion of any other elements.

The present invention provides a method for selectively separating a specific metal from a leach solution containing a metal mixture using a rotary reactor, including:
a) in the reactor which is rotating, forming an aqueous feed phase which contains the leach solution containing the metal mixture, an organic phase which includes one or more organic extractants for selectively extracting the specific metal from the aqueous feed phase and is formed adjacent to the aqueous feed phase, and an aqueous acceptor phase which is formed adjacent to the organic phase, in the form of concentric layers, respectively; and
b) transferring the specific metal in the aqueous feed phase to the aqueous acceptor phase by the organic extractant included in the organic phase and acting as a molecular shuttle between an aqueous feed phase/organic phase interface and an organic phase/aqueous acceptor phase interface,
wherein the aqueous acceptor phase has a higher density than the organic phase,
the aqueous feed phase and the aqueous acceptor phase are not formed adjacent to each other, and
the aqueous feed phase has a higher pH than the aqueous acceptor phase.

In the method, an example of the shape of the rotary reactor may include a cylindrical reactor without limitation. However, as long as an area where the aqueous feed phase, the organic phase, and the aqueous acceptor phase are formed in the form of concentric layers is provided inside the reactor which is rotating, the shape of the reactor is not particularly limited.

In the method, the specific metal which is selectively separated from the leach solution containing a metal mixture may be one or two or more. In addition, the organic extractant for separating the specific metal is one or more, and may be one or two or more. In addition, the specific metal which is selectively separated may be in a cation and/or a neutral state.

In the method, a non-limiting example of the leach solution containing a metal mixture may include a leach solution of a waste lithium ion battery; a concentrated leach solution of a rare earth element ore including thorium and uranium; a leach solution containing dysprosium, praseodymium, terbium, and neodymium; or a leach solution containing hafnium and zirconium, but is not limited thereto.

As an example of the method, a method for selectively separating thorium and uranium from the concentrated leach solution of a rare earth element ore including thorium and uranium may be provided, and also a known organic extractant which may extract thorium and uranium may be used.

As an example of the method, a method for separating neodymium from the leach solution containing dysprosium, praseodymium, terbium, and neodymium may be provided, and also, a known organic extractant which may extract neodymium may be used.

As an example of the method, a method for separating zirconium from the leach solution containing hafnium and zirconium may be provided, and also, a known organic extractant which may extract zirconium may be used.

As a preferred example of the method, a method for separating a specific metal from a metal mixture of the leach solution of a waste lithium ion battery may be provided, and also, a known organic extractant which may extract the specific metal may be used.

The leach solution of the waste lithium ion battery may be specifically, a leach solution of a cathode of the waste lithium ion battery, and more specifically, a leach solution of a cathode active material of the waste lithium ion battery.

The cathode active material may be a composite metal oxide of lithium with at least one selected from cobalt, manganese, and nickel, and for example, LiCoO₂, LiMnₓO_{2X} (x=1, 2), LiN₁₋ₓMnₓO_{2X} (0<x<1), LiNi_{1-x-y}CoₓMn_{y}O₂ (0≤x≤0.5, 0≤y≤0.5), or the like.

As a more preferred example of the method, a method for selectively separating at least one or more of cobalt, manganese, and nickel from the leach solution of the cathode active material (LiNi_{1-x-y}CoₓMn_{y}O₂, 0≤x≤0.5, 0≤y≤0.5) of the waste lithium ion battery may be provided, and also, a known organic extractant which may extract at least one or more of cobalt, manganese, and nickel may be used.

As the most preferred example of the method, a method for selectively separating cobalt and manganese from the leach solution of the cathode active material (LiNi_{1-x-y}CoₓMn_{y}O₂, 0≤x≤0.5, 0≤y≤0.5) of the waste lithium ion battery may be provided, and also, a known organic extractant which may extract cobalt and manganese may be used. Herein, the organic extractant may be preferably a phosphorus-based extractant, and, for example, may be at least one or more of Cyanex 301 (bis(2,4,4-trimethylpentyl)dithiophosphinic acid), Cyanex 272 (bis(2,4,4-trimethylpentyl)phosphinic acid), PC88A (2-ethylhexyl phosphoric acid mono-2-ethylhexyl ester), and D2EHPA (di-2-ethylhexylphosphoric acid).

The leach solution of the cathode active material of the waste lithium ion battery may be preferably an acid leach solution, and specifically, may be prepared by a known method exemplified in the descriptions of the previous Non-Patent Documents 2 and 3. More specifically, the acid leach solution may be prepared by discharging a lithium ion battery, disassembling the discharged lithium ion battery to separate a cathode, separating a cathode active material again from the separated cathode, and acid leaching the separated cathode active material using an acid solution. Herein, in the acid solution, a concentration of the acid exemplified by sulfuric acid, nitric acid, hydrochloric acid, or the like may be 1 to 8 M. In particular, preferably, the acid leaching may be performed under a reducing atmosphere, using the acid solution and a reducing agent together. As the reducing agent, preferably hydrogen peroxide may be used, and the concentration of the hydrogen peroxide herein may be preferably 2 to 10 vol %.

In the method, the aqueous feed phase and the aqueous acceptor phase are not formed adjacent to each other, inside the reactor which is rotating. In addition, in the reactor which is rotating, since the aqueous feed phase and the organic phase are formed adjacent to each other, a membrane is not provided between the aqueous feed phase and the organic phase. In addition, in the reactor which is rotating, since the organic phase and the aqueous acceptor phase are also adjacent to each other, a membrane is not provided between the organic phase and the aqueous acceptor phase.

In the method, the organic extractant of the organic phase acts as a molecule shuttle between an aqueous feed phase/organic phase interface and an organic phase/aqueous acceptor phase interface, thereby transferring a specific metal in the aqueous feed phase to the aqueous acceptor phase. Herein, organic extractant molecules may shuttle between an aqueous feed phase/organic phase interface and an organic phase/aqueous acceptor phase interface several times, and each extractant molecule may transfer up to 10 metal ions. That is, since the aqueous feed phase, the organic phase, and the aqueous acceptor phase in the reactor which is rotating are formed in the form of stabilized concentric layers, and also, a pH difference between the aqueous feed phase and the aqueous acceptor phase, is provided, each extractant molecule is circulated several times between the two interfaces, so that a desired specific metal is gradually extracted from the aqueous feed phase to be transferred to the aqueous acceptor phase. Therefore, the method may effectively use a low-concentration extractant even in a highly concentrated feed phase by the shuttling action, show an excellent extraction/separation speed, and also, provide high selectivity to the subject to be separated.

More specifically, the organic extractant of the organic phase may preferably contain a proton. Herein, the extractant molecule in the aqueous feed phase/organic phase interface may form a coordinated species by exchanging the proton with a metal cation. In addition, when the formed coordinated species moves through the organic phase to reach the organic phase/aqueous acceptor phase interface, the metal flows into the aqueous acceptor phase to exchange the metal with the proton of the aqueous acceptor phase. Herein, transferring the specific metal in the aqueous feed phase to the aqueous acceptor phase may be interpreted as driving by the gradient and flow of protons in the opposite direction. A non-limiting example of the organic extractant containing a proton may be at least one of Cyanex 301, Cyanex 272, PC88A, and D2EHPA.

Therefore, in the method, the organic phase includes an organic solvent; and an organic extractant acting as a molecular shuttle and may be referred to as a shuttle phase.

In step a), preferably, the pH of the aqueous feed phase may be more than 2 and 6.8 or less, and the pH of the aqueous acceptor phase may be 0 or more and 1 or less. In step a), more preferably, the pH of the aqueous feed phase may be more than 3 and 6.5 or less, and the pH of the aqueous acceptor phase may be 0 or more and 0.5 or less. Herein, the aqueous acceptor phase includes an acid exemplified by sulfuric acid, nitric acid, hydrochloric acid, or the like, and specifically, may include an acid at a concentration of 5% (w/w) to 30% (w/w). In addition, in order to adjust the density of the aqueous acceptor phase to be higher than the density of the organic phase, selectively, a density regulator such as metal chlorides (e.g., NaCl, CsCl) may be included at a concentration of 5% (w/w) to 30% (w/w) in the aqueous acceptor phase.

In addition, in a shuttling process of step b) of the method, there is also a possibility that the pH of the aqueous feed phase is rapidly lowered. Accordingly, by performing steps a) and b) sequentially using a liquid material corresponding to the aqueous feed phase including an appropriate buffer, the pH of the aqueous feed phase may be maintained within the range corresponding to the pKa of the organic extractant in the shuttling process of step b). A non-limiting example of the buffer may be at least one or more of an acetate buffer, a formic acid buffer, and a formate buffer.

In the method, a volume ratio of the aqueous feed phase organic phase:aqueous acceptor phase may be preferably 1:1 to 2.5:1 to 1.5, and the volume ratio in the range may be appropriate for improving the efficiency of extraction and separation to be desired. In addition, the volume ratio of the aqueous feed phase:organic phase:aqueous acceptor phase may be more preferably 1:1 to 2:1, and most preferably 1:2:1.

In the method, the concentration of the organic extractant in the organic phase may be 0.5% (v/v) to 40% (v/v) without limitation. In particular, the method may be sufficient for performing the extraction/separation to be desired effectively even with use of the organic extractant at a relatively low concentration as compared with the conventional technologies. Accordingly, the case in which the organic extractant at a concentration equivalent to or higher than the concentration of the conventional technologies is used is also included in the range of the method.

Upon review of the specific first embodiment based on the method of the present invention,
the rotary reactor includes: a cylindrical reactor; and a drive unit which rotates the cylindrical reactor,
in step a), as a liquid material corresponding to the aqueous acceptor phase, a liquid material corresponding to the organic phase, and a liquid material corresponding to the aqueous feed phase are sequentially injected in the order into the cylindrical reactor which is rotating, the aqueous acceptor phase, the organic phase, and the aqueous feed phase are formed sequentially and adjacently in the order adjacent to or close to an inner side surface of the cylindrical reactor by a centrifugal force due to rotation of the cylindrical reactor,
wherein the aqueous acceptor phase has a higher density than the organic phase, and
the organic phase has a higher density than the aqueous feed phase.

First, in the first embodiment, for a method for forming the aqueous feed phase, the organic phase, and the aqueous acceptor phase in the form of concentric layers in the cylindrical reactor which is rotating, Patent Document 1 and Non-Patent Document 1 are referred.

Specifically, as in (a) of FIG. 1 according to a non-limiting example, a rotary reactor 10 of the first embodiment may include a cylindrical reactor 12; and a drive unit 14 which rotates the cylindrical reactor. In addition, the cylindrical reactor 12 included in the rotary reactor 10 may be preferably arranged in the horizontal direction of gravity.

The inner side surface of the cylindrical reactor of the first embodiment corresponds to the inner wall of the cylindrical reactor. In particular, when the cylindrical reactor is preferably arranged in the horizontal direction of gravity, the inner side surface is also arranged in the horizontal direction of gravity.

The cylindrical reactor in the first embodiment may be made of a cylindrical material, and the material may be one or two or more selected from the group consisting of SiNₓ, SiO₂, TiO₂, quartz, and Teflon (polytetrafluoroethylene) without limitation.

In particular, as shown in (a) and (b) of FIG. 1 regarding the first embodiment, the liquid material corresponding to the aqueous acceptor phase, the liquid material corresponding to the organic phase, and the liquid material corresponding to the aqueous feed phase are sequentially injected into the cylindrical reactor (density size: the liquid material corresponding to the aqueous acceptor phase>the liquid material corresponding to the organic phase>the liquid material corresponding to the aqueous feed phase), the liquid material corresponding to the aqueous acceptor phase which is injected first forms a concentric layer 1 of the aqueous acceptor phase adjacent to the inner side surface 12 of the cylindrical reactor, the liquid material corresponding to the organic phase which is injected second forms a concentric layer 2 of the organic phase adjacent to the concentric layer of the aqueous acceptor phase, and the liquid material corresponding to the aqueous feed phase which is finally injected forms a concentric layer 3 of the aqueous feed phase which is adjacent to the concentric layer of the organic phase and is the closest to the center of the reactor. More specifically, each liquid material may be injected into the cylindrical reactor through an inlet placed at the center of a cylindrical reactor stopper 11, and each of the liquid materials may be dropped onto the bottom surface inside the cylindrical reactor using a syringe without limitation.

The material of the cylindrical reactor stopper of the first embodiment may be one or two or more selected from the group consisting of SiNₓ, SiO₂, TiO₂, and quartz without limitation.

In the first embodiment, by the process of injecting the liquid material corresponding to the aqueous acceptor phase, the liquid material corresponding to the organic phase, and the liquid material corresponding to the aqueous feed phase sequentially into the cylindrical reactor which is rotating, mixing of the concentric layer of the aqueous acceptor phase and the concentric layer of the aqueous feed phase may be prevented.

In the first embodiment, the liquid material injected into the cylindrical reactor which is rotating forms a layer in a vertical direction toward the bottom surface of the cylindrical reactor, thereby forming a liquid concentric layer. In addition, in the liquid material injected into the cylindrical reactor which is rotating, when a centripetal force by rotation dominates a surface tension of the liquid material, it may be favorable for forming a concentric liquid layer. Accordingly, it is preferred to appropriately adjust a rotational speed of the cylindrical reactor and the surface tension of the liquid material.

In the first embodiment, the size of the cylindrical reactor is not particularly limited, and for example, may have an internal diameter of 60 to 200 mm and a height of 5 to 55 mm.

In step a) of the first embodiment, a rotational speed of the cylindrical reactor for forming the liquid concentric layer may be preferably 700 rpm or more, more preferably 700 rpm to 2000 rpm.

In step a) of the first embodiment, the thickness of each liquid concentric layer inside the cylindrical reactor which is rotating may be preferably 150 μm or more, more preferably 1 to 10 mm. When the thickness of the liquid concentric layer is smaller than 150 μm, the stability of the liquid concentric layer is only in a metastable state, and thus, a portion of the liquid concentric layer may collapse or break. Therefore, in order for the liquid concentric layer to have a thickness of 150 μm or more, the density of the injected liquid material, appropriate adjustment for the size and the rotational speed of the reactor as well as a density difference between adjacent liquid concentric layers, and/or the surface tension of the liquid concentric layer is preferred. For example, in the cylindrical reactor having an internal diameter of 60 to 200 mm and a height of 5 to 55 mm, the liquid concentric layer may have a thickness of 150 μm or more, by adjusting the density difference between adjacent liquid concentric layers to 0.05 kg/L or more and the rotational speed to 700 rpm or more.

In the first embodiment, the cylindrical reactor is rotated around its coaxial axis by the drive unit, thereby forming the liquid concentric layers inside the cylindrical reactor. The drive unit may be an electric motor, as an example.

In step b) for shuttling action of the first embodiment, when the cylindrical reactor is in a state of a solid-body rotation at which the reactor rotates only at a constant speed, purely diffusive transport for a certain metal may be relatively slow and inefficient between the aqueous feed phase/organic phase interface and the organic phase/aqueous acceptor phase interface. Therefore, in step b), in order to facilitate the transfer of a certain metal between the two interfaces, it is more preferred that the rotational speed of the cylindrical reactor is periodically accelerated and decelerated. Accordingly, the rotational speed of the cylindrical reactor may be accelerated and decelerated between 700 rpm and 2000 rpm every 10 seconds to 30 seconds, and more specifically, may be accelerated and decelerated between 750 rpm and 1500 rpm every 20 seconds.

Upon review of the specific second embodiment based on the method of the present invention,
the rotary reactor includes a cylindrical reactor; and an internal rotor provided with a common shaft which passes through center holes of external walls at both end portions of the cylindrical reactor,
as a first internal wall, a second internal wall, a third internal wall, and a fourth internal wall are sequentially arranged in a direction from one end portion of the both end portions toward the other end portion within the cylindrical reactor, a first segment between the external wall at one end portion and the first internal wall; a second segment between the first internal wall and the second internal wall; a third segment between the second internal wall and the third internal wall; a fourth segment between the third internal wall and the fourth internal wall; and a fifth segment between the fourth internal wall and the external wall at the other end portion are provided,
each of the first internal wall, the second internal wall, the third internal wall, and the fourth internal wall has a center hole through which the common shaft passes, each of the second internal wall and the third internal wall has holes at one radial position, and each of the first internal wall and the fourth internal wall has holes at each of two distinct radial positions,
the internal rotor has a form in which two propellers and one impeller are mounted on the common shaft, the two propellers are placed within the first segment and the fifth segment, respectively, and the one impeller is placed within the third segment,
in step a), within the first segment and the second segment, the aqueous feed phase and the organic phase are formed sequentially and adjacently in the order adjacent to an inner side surface of the cylindrical reactor by a centrifugal force due to rotation of the cylindrical reactor,
in step a), within the third segment, the organic phase is formed adjacent to an inner side surface of the cylindrical reactor by a centrifugal force due to rotation of the cylindrical reactor,
in step a), within the fourth segment and the fifth segment, the aqueous acceptor phase and the organic phase are formed sequentially and adjacently in the order adjacent to an inner side surface of the cylindrical reactor by a centrifugal force due to rotation of the cylindrical reactor,
the aqueous feed phase and the aqueous acceptor phase have higher densities than the organic phase,
in step a), the cylindrical reactor and the internal rotor rotate at the same speed as each other, and
in step b), a rotational speed (ω₀) of the cylindrical reactor is higher than a rotational speed (ω₁) of the internal rotor.

First, in the second embodiment, the method for forming the aqueous feed phase, the organic phase, and the aqueous acceptor phase in the form of concentric layers in the cylindrical reactor which is rotating is distinguished from Examples of Patent Document 1; and Non-Patent Document 1.

In the second embodiment, in step a), within the first segment and the second segment, as a liquid material corresponding to the aqueous feed phase and a liquid material corresponding to the organic phase are sequentially loaded in this order, the aqueous feed phase and the organic phase may be formed sequentially and adjacently in the order adjacent to an inner side surface of the cylindrical reactor by a centrifugal force due to rotation of the cylindrical reactor; within the third segment, as a liquid material corresponding to the organic phase is loaded, the organic phase may be formed adjacent to an inner side surface of the cylindrical reactor by a centrifugal force due to rotation of the cylindrical reactor; and within the fourth segment and the fifth segment, as a liquid material corresponding to the aqueous acceptor phase and a liquid material corresponding to the organic phase are sequentially loaded in this order, the aqueous acceptor phase and the organic phase may be formed sequentially and adjacently in the order adjacent to an inner side surface of the cylindrical reactor by a centrifugal force due to rotation of the cylindrical reactor.

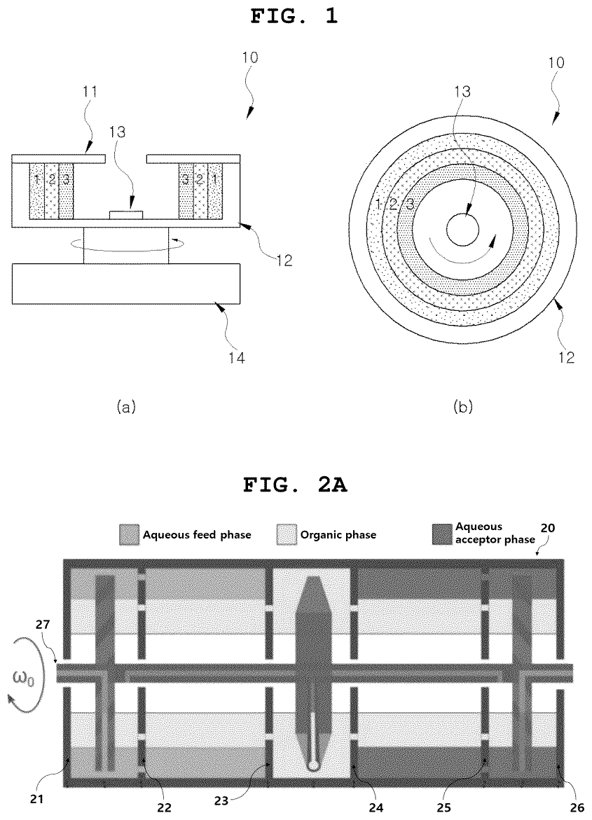

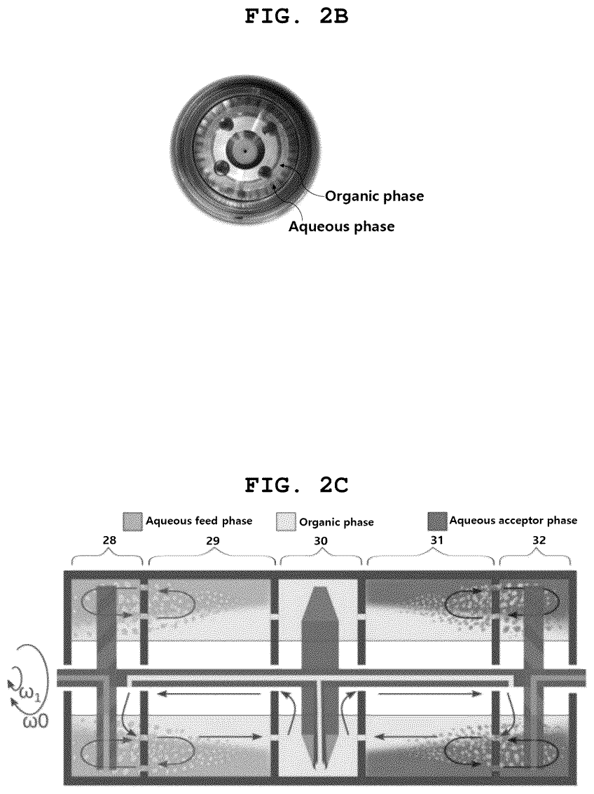

In the second embodiment, the structure and the shape of the rotary reactor may be concretized as shown in FIGS. 2A to 2C, and the cylindrical reactor 20 included in the rotary reactor may be arranged preferably in a horizontal direction which is the vertical direction of gravity. As a first internal wall 22, a second internal wall 23, a third internal wall 24, and a fourth internal wall 25 are sequentially arranged in a direction from an external wall 21 at one end portion of external walls 21 and 26 at both end portions of the cylindrical reactor 20 toward an external wall 26 at the other end portion, a first segment 28 between the external wall 21 at one end portion and the first internal wall 22; a second segment 29 between the first internal wall 22 and the second internal wall 23; a third segment 30 between the second internal wall 23 and the third internal wall 24; a fourth segment 31 between the third internal wall 24 and the fourth internal wall 25; and a fifth segment 32 between the fourth internal wall 25 and the external wall 26 at the other end portion are provided. Therefore, the inside of the cylindrical reactor of the second embodiment is separated into a plurality of segments, and each segment forms the liquid concentric layer in a differentiated form.

The inner side surface of the cylindrical reactor of the second embodiment corresponds to the inner wall of the cylindrical reactor. In particular, when the cylindrical reactor is preferably arranged in the vertical direction of gravity, the inner side surface is also arranged in the vertical direction of gravity.

Specifically, in step a) for forming the liquid concentric layers, within the first segment 28 and the second segment 29, as the liquid material corresponding to the aqueous feed phase and the liquid material corresponding to the organic phase are sequentially loaded in this order, the aqueous feed phase and the organic phase are formed sequentially and adjacently in the order adjacent to the inner side surface of the cylindrical reactor by a centrifugal force due to rotation of the cylindrical reactor 20. In addition, in step a), within the third segment 30, as the liquid material corresponding to the organic phase is loaded, the organic phase is formed adjacent to the inner side surface of the cylindrical reactor by a centrifugal force due to rotation of the cylindrical reactor 20. In addition, in step a), within the fourth segment 31 and the fifth segment 32, as the liquid material corresponding to the aqueous acceptor phase and the liquid material corresponding to the organic phase are sequentially loaded in this order, the aqueous acceptor phase and the organic phase are formed sequentially and adjacently in the order adjacent to the inner side surface of the cylindrical reactor a centrifugal force due to rotation of the cylindrical reactor 20.

In the second embodiment, step a) for forming the liquid concentric layers is performed in a non-stirring mode. Herein, the non-stirring mode means that the cylindrical reactor 20 included in the rotary reactor and the internal rotor 27 rotate at the same speed. In the rotary reactor of the second embodiment, though the cylindrical reactor 20 and the internal rotor 27 independently of each other rotate around the same rotation axis, the rotational speeds of the cylindrical reactor 20 and the internal rotor 27 are adjusted to be the same in the non-stirring mode. More specifically, FIG. 2A shows a form in which the liquid concentric layers are formed inside the cylindrical reactor 20 which is rotating under the non-stirring mode. In addition, a side view (along the rotation axis) of the rotary reactor according to FIG. 2A in the non-stirring mode may be shown as FIG. 2B, and it is confirmed that the aqueous phase (aqueous feed phase or aqueous acceptor phase) and the organic phase are formed in the form of concentric layers in the order adjacent to the inner side surface of the cylindrical reactor.

In the second embodiment, the common shaft which passes through center holes of the external walls 21 and 26 at both end portions of the cylindrical reactor 20 is provided in the internal rotor 27. Accordingly, each of the first internal wall 22, the second internal wall 23, the third internal wall 24, and the fourth internal wall 25 has a center hole through which the common shaft passes. In addition, each of the second internal wall 23 and the third internal wall 24 has holes at one radial position, and each of the first internal wall 22 and the fourth internal wall 25 has holes at each of two distinct radial positions. Herein, the radial position is based on the rotation axis of the cylindrical reactor 20 or the center hole of each of the internal walls. Specifically, as shown in FIG. 2A, each of the first internal wall 22 and the fourth internal wall 25 has holes at each of the two distinct radial positions, so that both the aqueous phase (aqueous feed phase or aqueous acceptor phase) and the organic phase permeate. However, as shown in FIG. 2A, each of the second internal wall 23 and the third internal wall 24 has holes at one specific radial position, so that only the organic phase permeates. Therefore, the aqueous feed phase; and the aqueous acceptor phase are limited to within the first and second segments 28 and 29; and within the fourth and fifth segments 31 and 32, respectively, but the organic phase is distributed in all segments.

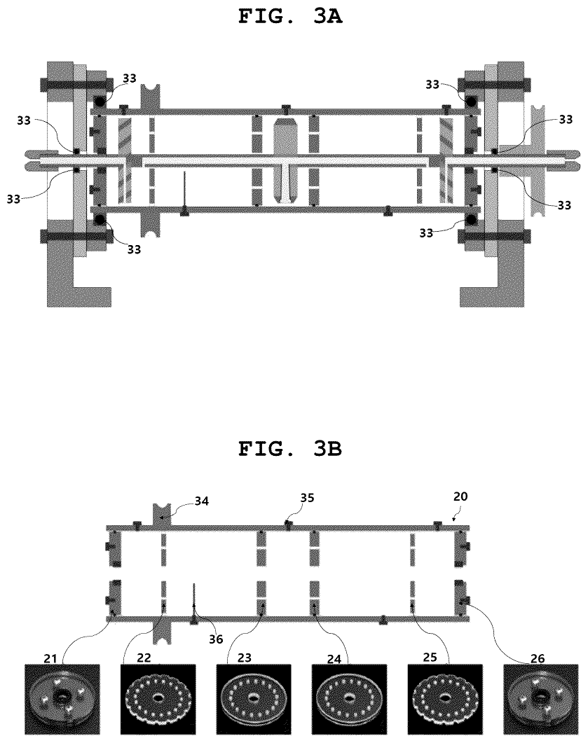

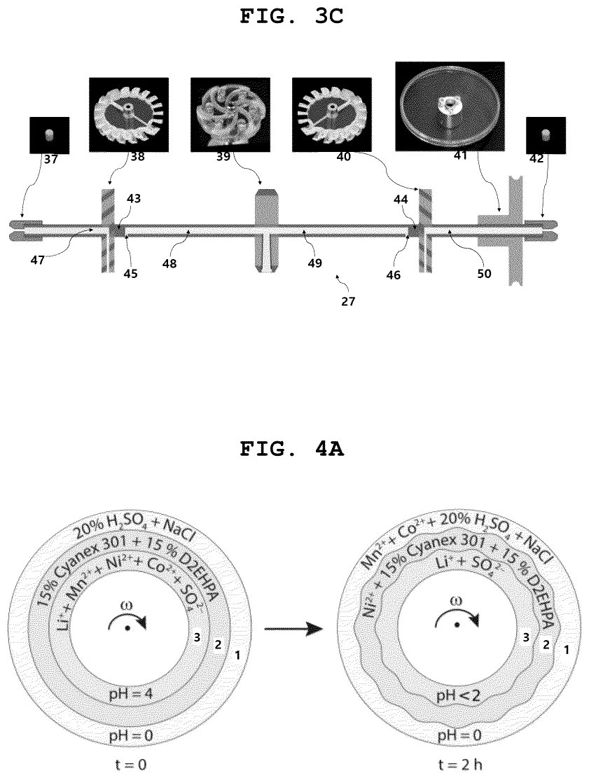

In the second embodiment, the structure and the shape of the rotary reactor including the cylindrical reactor 20 and the internal rotor 27 may be concretized, considering the illustrations of FIGS. 2A to 2C and FIGS. 3A to 3C together. First, FIG. 3A relates to an example of the rotary reactor provided with both the cylindrical reactor 20 and the internal rotor 27, and both the cylindrical reactor 20 and the internal rotor 27 may be supported by a static frame through a ball bearing 33.

FIG. 3B concretizes the structure and the shape of the cylindrical reactor 20 and may further concretize the structure and the shape of each of the external walls 21 and 26 at both end portions, the first internal wall 22, the second internal wall 23, the third internal wall 24, and the fourth internal wall 25. Herein, the plane shape of each of the external walls 21 and 26 at both end portions, the first internal wall 22, the second internal wall 23, and third internal wall 24, and the fourth internal wall 25 may be circular, and additionally, semicircular incisions may be formed on the circumference of the first internal wall 22 and the fourth internal wall 25. Herein, in the cylindrical reactor 20, the semicircular incisions formed on the circumference of the first internal wall 22 and the fourth internal wall 25 may act as holes of the radial position for permeation of the aqueous phase. Meanwhile, a plurality of accessory bolts (for example, 35) required for disassembly and assembly of the reactor may be mounted on the cylindrical reactor 20, and a venting needle 36 for achieving a balance between air pressure and atmospheric pressure inside the reactor may be further mounted on one or more accessory bolts.

According to FIG. 3C, the internal rotor 27 has a form in which two propellers 38 and 40 and one impeller 39 are mounted on the common shaft. In the cylindrical reactor 20, the two propellers 38 and 40 are placed within the first segment 28 and the fifth segment 32, respectively, and the one impeller 39 is placed within the third segment 30.

The material of the common shaft of the internal rotor 27 may be preferably an acid resistant steel, but is not limited thereto.

In particular, in the second embodiment, the densities of the aqueous feed phase and the aqueous acceptor phase formed inside the cylindrical reactor 20 only have to be higher than the density of the organic phase in common. Therefore, in the second embodiment, there is no need to monotonically increase the density in the order of “aqueous acceptor phase>organic phase>aqueous feed phase” as in the first embodiment.

In step b) for a shuttling action of the second embodiment, the rotational speed (ω₀) of the cylindrical reactor 20 is adjusted to be higher than the rotational speed (ω₁) of the internal rotor 27. Accordingly, in step b), the extraction/separation to be desired may be performed in earnest, by performing it in a stirring mode.

Specifically, according to the illustration of FIG. 2C showing the mechanism of the stirring mode, the organic phase is sucked into the impeller 39 in the third segment, and the sucked organic phase is pumped into each of the first segment 28 and the fifth segment 32 through the internal channel of the common shaft. Accordingly, the organic phase is emulsified with the aqueous feed phase by stirring of the propeller 38 in the first segment 28 to form an emulsion, the formed emulsion is pumped into the adjacent second segment 29 by the propeller 38, the emulsion is separated into the organic phase and the aqueous feed phase again by the centrifugal force in the second segment 29, and the separated aqueous feed phase returns to the first segment 28 again. Simultaneously, the organic phase is emulsified with the aqueous acceptor phase by stirring of the propeller 40 in the fifth segment 32 to form an emulsion, the formed emulsion is pumped into the adjacent fourth segment 31 by the propeller 40, the emulsion is separated into the organic phase and the aqueous acceptor phase again by the centrifugal force in the fourth segment 31, and the separated aqueous acceptor phase returns to the fifth segment 32 again. In addition, the organic phase is further sucked into the impeller 39 in the third segment 30 and is redistributed to the first segment 28 and the fifth segment 32, respectively, through the internal channel of the common shaft of the internal rotor 27. That is, in this way, the liquid is strongly circulated between the first segment 28 and the second segment 29; and between the fourth segment 31 and the fifth segment 32, and the organic phase is pumped into the first segment 28 and the fifth segment 32 again through the internal channel of the common shaft of the internal rotor 27. Accordingly, in this way, the aqueous feed phase; and the aqueous acceptor phase are limited within the first and second segments 28 and 29; and within the fourth and fifth segments 31 and 32, respectively, but the organic phase is distributed in all of the segments (and also circulated between the segments) and may be strongly stirred with the two aqueous phases. In particular, according to the method to which emulsion is applied, since an area of the interface between liquid phases may be increased, and also mixing near the phase and inside the phase may be further improved, a shuttling time between the aqueous feed phase/organic phase interface and the organic phase/aqueous acceptor phase interface may be shortened more effectively.

In step b) of the second embodiment, the rotational speed (ω₀) of the cylindrical reactor may be preferably 1200 to 6000 rpm, and the rotational speed (ω₁) of the internal rotor may be preferably 800 to 1000 rpm. In addition, the rotational speed (ω₀) of the cylindrical reactor may be more preferably 1500 to 4000 rpm.

In step b) of the second embodiment, preferably, the rotational speed (ω₀) of the cylindrical reactor may be 1.2 to 7.5 times higher than the rotational speed (ω₁) of the internal rotor. In addition, more preferably, the rotational speed (ω₀) of the cylindrical reactor may be 1.5 to 5 times higher than the rotational speed (ω₁) of the internal rotor.

In the second embodiment, both end portions of the common shaft of the internal rotor may be placed outside the cylindrical reactor, an inlet port may be provided at each of the both end portions of the common shaft, the liquid material corresponding to the aqueous feed phase may be injected into the cylindrical reactor through the inlet port at one end portion of the both end portions of the common shaft, the liquid material corresponding to the aqueous acceptor phase may be injected into the cylindrical reactor through the inlet port at the other end portion of the both end portions of the common shaft, and the liquid material corresponding to the organic phase may be injected into the cylindrical reactor through the inlet port at the other end portion of the both end portions of the common shaft.

More specifically, according to the illustration of FIG. 3C, the inlet port may be provided at each of the both end portions 37 and 42 of the common shaft of the internal rotor 27. In addition, upon further review of the illustrations of FIGS. 3A and 3B, in the combined structure of the internal rotor 27 and the cylindrical reactor 20, the both end portions 37 and 42 may be placed outside the cylindrical reactor 20. In addition, in the progress of step a) of the second embodiment, the liquid material corresponding to the aqueous feed phase may be injected into the cylindrical reactor 20 through the inlet port at one end portion 37 of the both end portions 37 and 42, and the liquid material corresponding to the aqueous acceptor phase may be injected into the cylindrical reactor 20 through the inlet port at the other end portion 42.

In the second embodiment, the common shaft of the internal rotor may be provided with a first internal channel; a third internal channel; and a second internal channel placed between the first internal channel and the third internal channel, the second internal channel may be separated from the first internal channel and the third internal channel by internal plugs, the first internal channel may be for transferring the liquid material corresponding to the aqueous feed phase from the inlet port at one end portion of the common shaft to the first segment in the cylindrical reactor, the third internal channel may be for transferring the liquid material corresponding to the aqueous acceptor phase from the inlet port at the other end portion of the common shaft to the fifth segment in the cylindrical reactor, and the second internal channel may be for distributing the organic phase sucked into the impeller in the third segment to the first and fifth segments in the cylindrical reactor.

More specifically, according to the illustration of FIG. 3C, a first internal channel 47; a third internal channel 50; and second internal channels 48 and 49 placed between the first internal channel 47 and the third internal channel 50 may be provided in the common shaft of the internal rotor 27, and the second internal channels 48 and 49 may be separated from the first internal channel 47 and the third internal channel 50 by internal plugs 43 and 44. In addition, in the progress of step a) of the second embodiment, the first internal channel 47 may be for transferring the liquid material corresponding to the aqueous feed phase from the inlet port at one end portion 37 of the common shaft to the first segment 28 in the cylindrical reactor 20, and the third internal channel 50 may be for transferring the liquid material corresponding to the aqueous acceptor phase from the inlet port of the other end portion 42 of the common shaft to the fifth segment 32 in the cylindrical reactor 20. In addition, in the progress of the stirring mode in step b) of the second embodiment, the second internal channels 48 and 49 may be for distributing the organic phase sucked into the impeller 39 in the third segment to the first segment 28 and the fifth segment 32 through orifices 45 and 46.

Still more specifically, in step a) of the second embodiment, the liquid material corresponding to the aqueous feed phase is transferred from the inlet port at one end portion 37 of the common shaft to the first segment 28 in the cylindrical reactor 20 through the first internal channel 47, an aqueous feed phase is formed adjacent to the inner side surface of the cylindrical reactor 20 by the centrifugal force due to rotation of the cylindrical reactor 20 in the first segment 28, the formed aqueous feed phase permeates the holes (those closer to the inner side surface of the reactor) at the radial position of the first internal wall 22 to be distributed to the portion adjacent to the inner side surface of the reactor in the second segment 29. In addition, the liquid material corresponding to the aqueous acceptor phase is transferred from the inlet port at the other end portion 42 of the common shaft to the fifth segment 32 in the cylindrical reactor 20 through the third internal channel 50, the aqueous acceptor phase is formed adjacent to the inner side surface of the cylindrical reactor 20 by the centrifugal force due to rotation of the cylindrical reactor 20 in the fifth segment 32, the formed aqueous acceptor phase permeates the holes (those closer to the inner side surface of the reactor) at the radial position of the fourth internal wall 25 to be distributed to the portion adjacent to the inner side surface of the reactor in the fourth segment 31. In this way, the aqueous feed phase and the aqueous acceptor phase are formed in the cylindrical reactor 20, the liquid material corresponding to the organic phase is transferred from the inlet port at the other end portion 42 of the common shaft to the fifth segment 32 in the cylindrical reactor 20, the organic phase is formed adjacent to the aqueous acceptor phase by the centrifugal force due to rotation of the cylindrical reactor 20 in the fifth segment 32, and the formed organic phase permeates the holes (in the case of the first and fourth internal walls, those closer to the center hole of the wall) at the radial position of the fourth internal wall 25, the third internal wall 24, the second internal wall 23, and the first internal wall 22 to be distributed in all segments.

According to FIG. 3B for the second embodiment, a driving pulley 34 may be mounted on an outer surface of the cylindrical reactor 20, and the cylindrical reactor 20 may rotate by a rotational force of the driving pulley. In addition, according to FIG. 3C, a driving pulley 41 may be further mounted on the common shaft of the internal rotor 27, in which the internal rotor 27 may rotate by a rotational force of the driving pulley 41 mounted on the common shaft. Accordingly, the cylindrical reactor 20 and the internal rotor 27 may rotate independently from each other by each electric motor connected to each of the driving pulleys 34 and 41.

In the second embodiment, each of the external walls of the both end portions, the first internal wall, the second internal wall, the third internal wall, and the fourth internal wall included in the cylindrical reactor may be made of a transparent plastic material, and the circumference of each of the external walls of the both end portions, the second internal wall, and the third internal wall may be sealed by an O-ring made of an elastic material. In addition, the transparent plastic material may be at least one selected from polypropylene (PP), polyethylene terephthalate (PET), and polymethyl methacrylate (PMMA) without limitation, and the O-ring made of an elastic material may be a fluoroelastomer O-ring without limitation. In particular, the cylindrical reactor provided with the external walls of the both end portions, the first internal wall, the second internal wall, the third internal wall, and the fourth internal wall may be entirely formed of a transparent material. Therefore, when the cylindrical reactor is entirely formed of a transparent material, a reaction state may be observed by a naked eye.

In the second embodiment, the size of the cylindrical reactor is not particularly limited, and for example, may have an internal diameter of 60 to 75 mm, an external diameter of 80 to 95 mm, and a length of 250 to 350 mm. Meanwhile, the size of the common shaft is also not particularly limited, and for example, may have a diameter of 8 to 20 mm and a length of 380 to 450 mm. In addition, the width of the internal channel of the common shaft may be 3 to 5 mm.

In addition, in the second embodiment, after performing step b), c) adjusting the rotational speed of the cylindrical reactor and the rotational speed of the internal rotor to be the same, and sampling the aqueous acceptor phase containing the specific metal through the inlet port at the other end portion of the common shaft may be further performed. More specifically, when the extraction/separation to be desired is completed by step b) in a stirring mode, the aqueous acceptor phase containing the specific metal may be sampled through the inlet port at the other end portion 42 of the common shaft in a state of being converted into a non-stirring mode.

Furthermore, according to the method of the present invention, a reaction system for selectively separating a specific metal from a leach solution containing a metal mixture using a rotary reactor is formed.

In the reaction system,
in the reactor which is rotating, an aqueous feed phase which contains the leach solution containing the metal mixture, an organic phase which includes one or more organic extractants for selectively extracting the specific metal from the aqueous feed phase and is formed adjacent to the aqueous feed phase, and an aqueous acceptor phase which is formed adjacent to the organic phase are formed in the form of concentric layers, respectively,
the specific metal in the aqueous feed phase is transferred to the aqueous acceptor phase by the organic extractant included in the organic phase and acting as a molecular shuttle between an aqueous feed phase/organic phase interface and an organic phase/aqueous acceptor phase interface,
wherein the aqueous acceptor phase has a higher density than the organic phase,
the aqueous feed phase and the aqueous acceptor phase are not formed adjacent to each other, and
the aqueous feed phase has a higher pH than the aqueous acceptor phase.

Upon review of the specific first embodiment based on the reaction system of the present invention,
the rotary reactor includes: a cylindrical reactor; and a drive unit which rotates the cylindrical reactor,
in the cylindrical reactor which is rotating, the aqueous acceptor phase, the organic phase, and the aqueous feed phase are formed sequentially and adjacently in the order adjacent to or close to an inner side surface of the cylindrical reactor by a centrifugal force due to rotation of the cylindrical reactor,
the aqueous acceptor phase has a higher density than the organic phase,
the organic phase has a higher density than the aqueous feed phase, and
a rotational speed of the cylindrical reactor is periodically accelerated and decelerated.

Upon review of the specific second embodiment based on the reaction system of the present invention,
the rotary reactor includes a cylindrical reactor; and an internal rotor provided with a common shaft which passes through center holes of external walls at both end portions of the cylindrical reactor,
as a first internal wall, a second internal wall, a third internal wall, and a fourth internal wall are sequentially arranged in a direction from one end portion of the both end portions toward the other end portion within the cylindrical reactor, a first segment between the external wall at one end portion and the first internal wall; a second segment between the first internal wall and the second internal wall; a third segment between the second internal wall and the third internal wall; a fourth segment between the third internal wall and the fourth internal wall; and a fifth segment between the fourth internal wall and the external wall at the other end portion are provided,
each of the first internal wall, the second internal wall, the third internal wall, and the fourth internal wall has a center hole through which the common shaft passes, each of the second internal wall and the third internal wall has holes at one radial position, and each of the first internal wall and the fourth internal wall has holes at each of two distinct radial positions,
the internal rotor has a form in which two propellers and one impeller are mounted on the common shaft, the two propellers are placed within the first segment and the fifth segment, respectively, and the one impeller is placed within the third segment,
within the first segment and the second segment, the aqueous feed phase and the organic phase are formed sequentially and adjacently in the order adjacent to an inner side surface of the cylindrical reactor by a centrifugal force due to rotation of the cylindrical reactor,
within the third segment, the organic phase is formed adjacent to an inner side surface of the cylindrical reactor by a centrifugal force due to rotation of the cylindrical reactor,
within the fourth segment and the fifth segment, the aqueous acceptor phase and the organic phase are formed sequentially and adjacently in the order adjacent to an inner side surface of the cylindrical reactor by a centrifugal force due to rotation of the cylindrical reactor,
the aqueous feed phase and the aqueous acceptor phase have higher densities than the organic phase, and
a rotational speed (ω₀) of the cylindrical reactor is adjusted to be higher than a rotational speed (ω₁) of the internal rotor.

Since the description for the configurations of the reaction system of the present invention overlaps with the above description for the method of the present invention, the detailed description thereof will be omitted.

### EXAMPLES

Hereinafter, the present invention will be described in more detail by the following examples.

However, the following examples are only illustrative of the present invention, and do not limit the disclosure of the present invention in any way.

### Example 1

Example 1 was based on the specific first embodiment of the method of the present invention.

A lithium ion battery available from LG Chem including a cathode active material LiNi_{0.85}Co_{0.10}Mn_{0.05}O₂ was used, and an acid leach solution of the cathode active material was prepared as follows by the known method described in the Non-Patent Document 2.

The battery was soaked in a brine including NaCl at a concentration of 10% (w/v) for 24 hours to completely discharge the battery. The discharged battery was manually disassembled, and cathode scraps were separated into small pieces. The cathode scraps in small pieces were treated with N-methylpyrrolidone (NMP) at 100 °C for 24 hours to separate a cathode active material from an aluminum current collector, and the separated cathode active material was filtered under vacuum and dried at 140 °C. Subsequently, both a sulfuric acid solution and hydrogen peroxide were added to a 250 mL Erlenmeyer flask at room temperature, the filtered and dried cathode active material was slowly added to the flask, and stirring was continuously performed at 300 rpm for 2 hours or more. After leaching, insoluble residues were separated by filtration, concentrations of Co, Ni, and Mn in the finally prepared acid leach solution were measured by inductively coupled plasma optical emission spectroscopy (ICP-OES).

The finally prepared acid leach solution by the process corresponded to the liquid material of the aqueous feed phase. Specifically, the properties and the compositions of the liquid materials corresponding to the aqueous feed phase, the organic phase (shuttle phase), and the aqueous acceptor phase (collector phase) used in Example 1 are shown in the following Table 1. In addition, the material of the aqueous feed phase of the following Table 1 can be reproduced also by a common preparation process of an acid aqueous solution, of course.

TABLE 1

| | |
|---|---|
| Aqueous | Volume: 10 mL; Density: 1.010 kg/L; pH: 4 |
| feed phase | Concentration of contained metal: Li⁺ 21.0 mM, |
| material | Ni²⁺ 18.3 mM, Mn²⁺ 1.1 mM, Co²⁺ 2.5 mM |
| (acid leach | |
| solution) | |
| Organic | Volume: 20 mL; Density: 1.085 kg/L |
| phase | Concentration of contained organic |
| material | extractant: Cyanex 301 15% (v/v), DEHPA 15% |
| | (v/v) |
| | Concentration of contained organic solvent: |
| | n-decane 37% (v/v), TCE (tetrachloroethylene) |
| | 33% (v/v) |
| Aqueous | Volume: 10 mL; Density: 1.150 kg/L; pH: 0 |
| acceptor | Concentration of contained sulfuric acid: |
| phase | 20% (w/w) |
| material | Concentration of contained NaCl: 20% (w/w) |

In addition, the reactor in the form of FIG. 1 arranged in the horizontal direction of gravity was used, and as a drive unit for rotating a cylindrical reactor (internal diameter: 75 mm, height: 11 mm), an electric motor was used. As a material of the side surface and the bottom surface inside the cylindrical reactor, Teflon (polytetrafluoroethyloene) was used. A cylindrical reactor stopper made of quartz was silanized with vapor-deposited 1H,1H,2H,2H-perfluorooctyltrichlorosilane. In addition, a mandrel 13 made of a stainless steel was used.

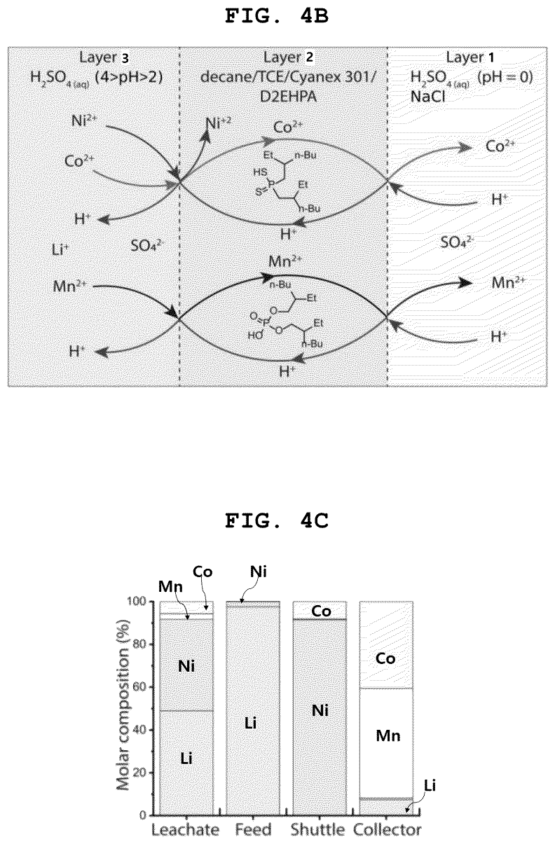

First, the liquid material of the aqueous acceptor phase, the liquid material of the organic phase, and the liquid material of the aqueous feed phase were sequentially injected into the cylindrical reactor rotating at a rotational speed of 1500 rpm. Accordingly, it was confirmed that the aqueous acceptor phase, the organic phase, and the aqueous feed phase were formed in the form of concentric layers in the order adjacent to an inner side surface of the cylindrical reactor (“t=0” of FIG. 4A).

Subsequently, the rotational speed of the cylindrical reactor was accelerated and decelerated between 750 rpm and 1500 rpm every 20 seconds, thereby effectively performing the shuttling process of the diagram of FIG. 4B. According to the diagram of FIG. 4B, extractant (Cyanex 301 and D2EHPA) molecules exchange protons with metal cations (Co²⁺ and Mn²⁺) in the aqueous feed phase/organic phase interface, thereby forming coordinated species. In addition, when the formed coordinated species move through the organic phase to reach the organic phase/aqueous acceptor phase interface, the metal cations (Co²⁺ and Mn²⁺) flow into the aqueous acceptor phase to exchange the metal cations (Co²⁺ and Mn²⁺) with protons of the aqueous acceptor phase. At this time, transferring the specific metals (Co²⁺ and Mn²⁺) from the aqueous feed phase to the aqueous acceptor phase is driven by the gradient and flow of protons in the opposite direction.

Finally, the rotational speed of the cylindrical reactor was accelerated and decelerated periodically for 2 hours (“t=2 h” of FIG. 4A), and the metal distribution map of each liquid phase which was shuttled after the reaction was measured by ICP-OES. Accordingly, FIG. 4C shows a metal distribution map of the aqueous feed phase (Leachate) before treatment, and also, a metal distribution map of each treated liquid phase (feed, shuttle, collector). Specifically, it was confirmed that the treated aqueous feed phase (feed) included a high content (Li⁺ 97.6 mol %) of Li⁺, but the treated aqueous acceptor phase (collector) had a high combined content of Co²⁺ and Mn²⁺. More specifically, it was confirmed that 99% of Co²⁺ and Mn²⁺ were transferred to the aqueous acceptor phase, based on the concentrations of Co²⁺ and Mn²⁺ in the aqueous feed phase before the treatment.

Accordingly, according to the method applied to Example 1, the specific metals (Co²⁺ and Mn²⁺) were extracted and separated with high selectivity from the acid leach solution of the cathode active material of a waste lithium ion battery, and thus, extraction/separation to be desired in one reactor may be efficiently performed in terms of time and space.

### Example 2

Example 2 was based on the specific first embodiment of the method of the present invention.

A lithium ion battery available from LG Chem including a cathode active material LiNi_{0.85}Co_{0.10}Mn_{0.05}O₂ was used, and an acid leach solution of the cathode active material was prepared as follows by the known method described in the Non-Patent Document 2.

The battery was soaked in a brine including NaCl at a concentration of 10% (w/v) for 24 hours to completely discharge the battery. The discharged battery was manually disassembled, and cathode scraps were separated into small pieces. The cathode scraps in small pieces were treated with N-methylpyrrolidone (NMP) at 100 °C for 24 hours to separate a cathode active material from an aluminum current collector, and the separated cathode active material was filtered under vacuum and dried at 140 °C. Subsequently, both a sulfuric acid solution and hydrogen peroxide were added to a 250 mL Erlenmeyer flask at room temperature, the filtered and dried cathode active material was slowly added to the flask, and stirring was continuously performed at 300 rpm for 2 hours or more. After leaching, insoluble residues were separated by filtration, concentrations of Co, Ni, and Mn in the finally prepared acid leach solution were measured by inductively coupled plasma optical emission spectroscopy (ICP-OES).

In Example 2, the acid leach solution which was finally prepared by the above process was further buffered with an acetate (CH₃COO⁻, OAc⁻) buffer, thereby preparing the liquid material of the aqueous feed phase. Specifically, the properties and the compositions of the liquid materials corresponding to the aqueous feed phase, the organic phase, and the aqueous acceptor phase used in Example 2 are shown in the following Table 2. In addition, the material of the aqueous feed phase of the following Table 2 can be reproduced also by a common preparation process of an acid aqueous solution, of course.

TABLE 2

| | |
|---|---|
| Aqueous | Volume: 13 mL; Density: <1.08 kg/L; pH: 6.5 |
| feed phase | Concentration of contained component: Li⁺ 600 |
| material | mM, Ni²⁺ 555 mM, Co²⁺ 75 mM, Mn²⁺ 30 mM, SO₄²⁻ |
| | 405 mM, OAc⁻ 1110 mM |
| Organic | Volume: 17 mL; Density: 1.08 kg/L |
| phase | Concentration of contained organic |
| material | extractant: PC88A 5% (v/v) |
| | Concentration of contained organic solvent: |
| | n-decane 56% (v/v), TCE (tetrachloroethylene) |
| | 39% (v/v) |
| Aqueous | Volume: 13 mL; Density: >1.08 kg/L; pH: 0 |
| acceptor | Concentration of contained sulfuric acid: 20% |
| phase | (w/w) |
| material | Concentration of contained CsCl: 20% (w/w) |

In addition, the same reactor as that used in Example 1 was used, and the forming and shuttling processes of the liquid concentric layers were also performed in the same manner as in Example 1.

Finally, the rotational speed of the cylindrical reactor was accelerated and decelerated periodically for 5.5 hours, and the metal distribution map of each liquid phase which was shuttled after the reaction was measured by ICP-OES. Specifically, it was confirmed that the treated aqueous feed phase included 50.07 mol % of Li, 49.86 mol % of Ni, and 0.07 mol % of Co. However, it was confirmed that 99% or more of Co²⁺ and Mn²⁺ were transferred to the aqueous acceptor phase, based on the concentrations of Co²⁺ and Mn²⁺ in the aqueous feed phase before the treatment.

In Example 2, though an aqueous feed phase having a much higher concentration degree than Example 1 was used, an excellent separation speed was shown even with the use of the extractant having a much lower concentration than Example 1, and high selectivity to a subject to be separated (Co²⁺ and Mn²⁺) was provided.

### Example 3

Example 3 was based on the specific second embodiment of the method of the present invention.

A lithium ion battery available from LG Chem including a cathode active material LiNi_{0.85}Co_{0.10}Mn_{0.05}O₂ was used, and an acid leach solution of the cathode active material was prepared as follows by the known method described in the Non-Patent Document 2.

The battery was soaked in a brine including NaCl at a concentration of 10% (w/v) for 24 hours to completely discharge the battery. The discharged battery was manually disassembled, and cathode scraps were separated into small pieces. The cathode scraps in small pieces were treated with N-methylpyrrolidone (NMP) at 100 °C for 24 hours to separate a cathode active material from an aluminum current collector, and the separated cathode active material was filtered under vacuum and dried at 140 °C. Subsequently, both a sulfuric acid solution and hydrogen peroxide were added to a 250 mL Erlenmeyer flask at room temperature, the filtered and dried cathode active material was slowly added to the flask, and stirring was continuously performed at 300 rpm for 2 hours or more. After leaching, insoluble residues were separated by filtration, concentrations of Co, Ni, and Mn in the finally prepared acid leach solution were measured by inductively coupled plasma optical emission spectroscopy (ICP-OES).

In Example 3, the acid leach solution which was finally prepared by the above process was further buffered with an acetate (CH₃COO⁻, OAc⁻) buffer, thereby preparing the liquid material of the aqueous feed phase. Specifically, the properties and the compositions of the liquid materials corresponding to the aqueous feed phase, the organic phase, and the aqueous acceptor phase used in Example 3 are shown in the following Table 3. However, the densities of the aqueous feed phase material and the aqueous acceptor phase material are higher in common than the density of the organic phase material. In addition, the material of the aqueous feed phase of the following Table 3 can be reproduced also by a common preparation process of an acid aqueous solution, of course.

TABLE 3

| | |
|---|---|
| Aqueous | Volume: 150 mL; pH: 6.5 |
| feed phase | Concentration of contained component: Li⁺ 600 |
| material | mM, Ni²⁺ 600 mM, Co²⁺ 75 mM, Mn²⁺ 30 mM, SO₄²⁻ |
| | 405 mM, OAc⁻ 1200 mM |
| Organic | Volume: 250 mL |
| phase | Concentration of contained organic |
| material | extractant : PC88A 1% (v/v) |
| | Concentration of contained organic solvent: |
| | octane 99% (v/v) |
| Aqueous | Volume: 150 mL; pH: <0.5 |
| acceptor | Concentration of contained sulfuric acid: 10% |
| phase | (w/w) |
| material | |

In addition, a rotary reactor in which the cylindrical reactor in the form of FIG. 3B and the internal rotor in the form of FIG. 3C were combined was used, and the shape of the rotary reactor arranged in the vertical direction of gravity is shown in FIGS. 2A to 2C and 3A.

The cylindrical reactor has an internal diameter of 70 mm, an external diameter of 80 mm, and a length of 300 mm, has the external walls 21 and 26 at both end portions, the first internal wall 22, the second internal wall 23, the third internal wall 24, and the fourth internal wall 25 in a circular plane shape, and is formed entirely of a transparent PMMA material. Additionally, the circumference of each of the external walls 21 and 26 of the both end portions, the second internal wall 23, and the third internal wall 24 is sealed by a fluoroelastomer O-ring. In the combined rotary reactor, the common shaft of the internal rotor is formed of an acid resistant steel material, and passes through center holes of the external walls 21 and 26 at the both end portions. Therefore, in order to prevent the liquid from being evaporated or splashing through a gap between the center hole of the external walls 21 and 26 at the both end portions and the common shaft, a rotary sealing collar is coated around the center hole of the external walls 21 and 26 at the both end portions. Four accessory bolts are mounted on each of the external walls 21 and 26 at the both end portions, and the first internal wall 22, the second internal wall 23, the third internal wall 24, and the fourth internal wall 25 also have a center hole through which the common shaft passes. The first internal wall 22, the second internal wall 23, the third internal wall 24, and the fourth internal wall 25 have in common circular through holes of 3 mm at the specific radial position (at 24 mm based on the rotation axis of the cylindrical reactor). Additionally, semicircular incisions of 3 mm are formed on the circumference of the first internal wall 22 and the fourth internal wall 25, and the semicircular incisions act as holes at the radial position for permeation of the aqueous phase. The common shaft of the internal rotor has a diameter of 10 mm and a length of 400 mm, and the width of the internal channel of the common shaft is 5 mm. In addition, a Teflon cap is coated around the inlet port at each of both end portions 37 and 42 of the common shaft. The cylindrical reactor and the internal rotor rotate independently of each other around the same rotation axis, by each electric motor connected to each of the driving pulleys 34 and 41.

In the non-stirring mode in which the rotational speeds of the cylindrical reactor (ω₀) and the internal rotor (ω₁) of the rotary reactor were the same at 1800 rpm, the aqueous feed phase material was transferred from the inlet port at one end portion 37 of the common shaft to the first segment 28 in the cylindrical reactor through the first internal channel 47 of the common shaft, the aqueous feed phase was formed in the form of a concentric layer adjacent to the inner side surface of the reactor by the centrifugal force due to rotation of the reactor in the first segment 28, and the formed aqueous feed phase permeated the holes (semicircular incisions) at the radial position of the first internal wall 22 to be extended to the portion adjacent to the inner side surface of the reactor in the second segment 29. Next, the aqueous acceptor phase material was transferred from the inlet port at the other end portion 42 of the common shaft to the fifth segment 32 in the cylindrical reactor through the third internal channel 50 of the common shaft, the aqueous acceptor phase was formed in the form of a concentric layer adjacent to the inner side surface of the reactor by the centrifugal force due to rotation of the reactor in the fifth segment 32, and the formed aqueous acceptor phase permeated the holes (semicircular incisions) at the radial position of the fourth internal wall 25 to be extended to the portion adjacent to the inner side surface of the reactor in the fourth segment 31. Next, the organic phase material was transferred from the inlet port at the other end portion 42 of the common shaft to the fifth segment 32 in the cylindrical reactor, the organic phase was formed in the form of a concentric layer adjacent to the aqueous acceptor phase by the centrifugal force due to rotation of the reactor in the fifth segment 32, and the formed organic phase permeated the holes at the radial position (at 24 mm based on the rotation axis of the cylindrical reactor) of the fourth internal wall 25, the third internal wall 24, the second internal wall 23, and the first internal wall 22 to be extended to all of the segments. As a series of the processes were performed in the non-stirring mode, it was confirmed that the distribution form of the liquid concentric layers in the cylindrical reactor was as shown in FIG. 2A. In addition, since the cylindrical reactor is entirely formed of a transparent material, the color of the liquid concentric layers was observed by the naked eye. The aqueous feed phase, the organic phase, and the aqueous acceptor phase formed in the reactor were observed as dirty green, colorless, and colorless, respectively.

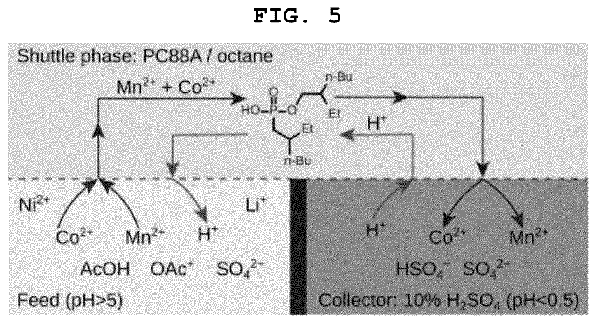

Subsequently, the rotational speeds of the cylindrical reactor (ω₀) and the internal rotor (ω₁) were adjusted differently to 1800 rpm and 900 rpm respectively, thereby performing the shuttling process by the diagram of FIG. 5 and the mechanism of FIG. 2C in earnest, in the stirring mode. During the performance of the shuttling process, it was observed that the organic phase turned blue as it contained PC88A-Co²⁺ coordinated species, the aqueous acceptor phase gradually turned pink as it received Co²⁺ and Mn²⁺, and the aqueous feed phase turned light green. Finally, after performing the shuttling process for 50 minutes, it was observed that the organic phase became transparent again (observed in the third segment 30 which is the middle area of the reactor), which means that there was almost no additional Co²⁺ to be transferred and the shuttling process was completed.

After confirming the completion of the shuttling process as described above, the rotational speeds of the cylindrical reactor (ω₀) and the internal rotor (ω₁) were adjusted the same as 1800 rpm, thereby converting to the non-stirring mode again. Under the non-stirring mode, the aqueous feed phase and the aqueous acceptor phase were sampled through the inlet port of each of the both end portions 37 and 42 of the common shaft. As a result of measuring metal distribution map of the shuttled aqueous feed phase by ICP-OES, purity of Li⁺ and Ni²⁺ was confirmed to be 99%.

Therefore, according to the method applied to Example 3, it was confirmed that a much faster separation speed was shown even with the use of the extractant at a lower concentration than Examples 1 and 2. In particular, in Example 3, though a highly concentrated aqueous feed phase was used like Example 2 according to the first embodiment, it was shown that a separation speed was 6 times or more faster for the subject to be separated. That is, in Example 3, an unprecedentedly high separation speed for the leach solution of the cathode active material of the waste lithium ion battery was achieved.

### Example 4

The processes were performed in the same manner as in Example 3, except that the organic phase material having the property and the composition shown in the following Table 4 was used.

TABLE 4

| | |
|---|---|
| Organic | Volume: 250 mL |
| phase | Concentration of contained organic |
| material | extractant: PC88A 5% (v/v) |
| | Concentration of contained organic solvent: |
| | octane 95% (v/v) |

After performing the shuttling process for 10 minutes, it was observed that the organic phase of the cylindrical reactor became transparent again. After confirming that the shuttling process was completed as described above, it was confirmed that purity of Li⁺ and Ni²⁺ was 99% in the shuttled aqueous feed phase.

Therefore, in Example 4, though a highly concentrated aqueous feed phase was used like Example 2 according to the first embodiment, it was shown that a separation speed was 30 times or more much faster for the subject to be separated. That is, in Example 4, an unprecedentedly high separation speed for the leach solution of the cathode active material of the waste lithium ion battery was achieved.

1. A method for selectively separating a specific metal from a leach solution containing a metal mixture using a rotary reactor, the method comprising:
a) in the reactor which is rotating, forming an aqueous feed phase which contains the leach solution containing the metal mixture, an organic phase which includes one or more organic extractants for selectively extracting the specific metal from the aqueous feed phase and is formed adjacent to the aqueous feed phase, and an aqueous acceptor phase which is formed adjacent to the organic phase, in the form of concentric layers, respectively; and
b) transferring the specific metal in the aqueous feed phase to the aqueous acceptor phase by the organic extractant included in the organic phase and acting as a molecular shuttle between an aqueous feed phase/organic phase interface and an organic phase/aqueous acceptor phase interface,
wherein the aqueous acceptor phase has a higher density than the organic phase,
the aqueous feed phase and the aqueous acceptor phase are not formed adjacent to each other, and
the aqueous feed phase has a higher pH than the aqueous acceptor phase.

2. The method of claim 1, wherein the leach solution is a leach solution of a waste lithium ion battery.

3. The method of claim 1, wherein in step a), the pH of the aqueous feed phase is more than 2 and 6.8 or less, and the pH of the aqueous acceptor phase is 0 or more and 1 or less.

4. The method of claim 1, wherein a volume ratio of the aqueous feed phase:the organic phase:the aqueous acceptor phase is 1:1 to 2.5:1 to 1.5.

5. The method of claim 1, wherein a concentration of the organic extractant in the organic phase is 0.5% (v/v) to 40% (v/v).

6. The method of claim 1,
wherein the rotary reactor includes: a cylindrical reactor; and a drive unit which rotates the cylindrical reactor,
in step a), as a liquid material corresponding to the aqueous acceptor phase, a liquid material corresponding to the organic phase, and a liquid material corresponding to the aqueous feed phase are sequentially injected in the order into the cylindrical reactor which is rotating, the aqueous acceptor phase, the organic phase, and the aqueous feed phase are formed sequentially and adjacently in the order adjacent to or close to an inner side surface of the cylindrical reactor by a centrifugal force due to rotation of the cylindrical reactor,
the aqueous acceptor phase has a higher density than the organic phase, and
the organic phase has a higher density than the aqueous feed phase.

7. The method of claim 6, wherein in step b), a rotational speed of the cylindrical reactor is periodically accelerated and decelerated.

8. The method of claim 7, wherein in step b), the rotational speed of the cylindrical reactor is accelerated and decelerated between 700 rpm and 2000 rpm every 10 to 30 seconds.

9. The method of claim 1,
wherein the rotary reactor includes a cylindrical reactor; and an internal rotor provided with a common shaft which passes through center holes of external walls at both end portions of the cylindrical reactor,
as a first internal wall, a second internal wall, a third internal wall, and a fourth internal wall are sequentially arranged in a direction from one end portion of the both end portions toward the other end portion within the cylindrical reactor, a first segment between the external wall at one end portion and the first internal wall; a second segment between the first internal wall and the second internal wall; a third segment between the second internal wall and the third internal wall; a fourth segment between the third internal wall and the fourth internal wall; and a fifth segment between the fourth internal wall and the external wall at the other end portion are provided,
each of the first internal wall, the second internal wall, the third internal wall, and the fourth internal wall has a center hole through which the common shaft passes, each of the second internal wall and the third internal wall has holes at one radial position, and each of the first internal wall and the fourth internal wall has holes at each of two distinct radial positions,
the internal rotor has a form in which two propellers and one impeller are mounted on the common shaft, the two propellers are placed within the first segment and the fifth segment, respectively, and the one impeller is placed within the third segment,
in step a), within the first segment and the second segment, the aqueous feed phase and the organic phase are formed sequentially and adjacently in the order adjacent to an inner side surface of the cylindrical reactor by a centrifugal force due to rotation of the cylindrical reactor,
in step a), within the third segment, the organic phase is formed adjacent to an inner side surface of the cylindrical reactor by a centrifugal force due to rotation of the cylindrical reactor,
in step a), within the fourth segment and the fifth segment, the aqueous acceptor phase and the organic phase are formed sequentially and adjacently in the order adjacent to an inner side surface of the cylindrical reactor by a centrifugal force due to rotation of the cylindrical reactor,
the aqueous feed phase and the aqueous acceptor phase have higher densities than the organic phase,
in step a), the cylindrical reactor and the internal rotor rotate at the same speed as each other, and
in step b), a rotational speed (ω₀) of the cylindrical reactor is higher than a rotational speed (ω₁) of the internal rotor.

10. The method of claim 9, wherein in step b), the rotational speed (ω₀) of the cylindrical reactor is 1200 to 6000 rpm, and the rotational speed (ω₁) of the internal rotor is 800 to 1000 rpm.

11. The method of claim 9, wherein in step b), the rotational speed (ω₀) of the cylindrical reactor is 1.2 to 7.5 times higher than the rotational speed (ω₁) of the internal rotor.

12. The method of claim 9,
wherein both end portions of the common shaft of the internal rotor are placed outside the cylindrical reactor,
an inlet port is provided at each of the both end portions of the common shaft,
a liquid material corresponding to the aqueous feed phase is injected into the cylindrical reactor through the inlet port at one end portion of the both end portions of the common shaft,
a liquid material corresponding to the aqueous acceptor phase is injected into the cylindrical reactor through the inlet port at the other end portion of the both end portions of the common shaft, and
a liquid material corresponding to the organic phase is injected into the cylindrical reactor through the inlet port at the other end portion of the both end portions of the common shaft.

13. The method of claim 12,
wherein a first internal channel, a third internal channel, and a second internal channel placed between the first internal channel and the third internal channel are provided in the common shaft of the internal rotor,
the second internal channel is isolated from the first internal channel and the third internal channel by internal plugs,
the first internal channel is for transferring the liquid material corresponding to the aqueous feed phase from the inlet port at one end portion of the common shaft to the first segment in the cylindrical reactor,
the third internal channel is for transferring the liquid material corresponding to the aqueous acceptor phase from the inlet port at the other end portion of the common shaft to the fifth segment in the cylindrical reactor, and
the second internal channel is for distributing the organic phase sucked into the impeller in the third segment to the first and fifth segments in the cylindrical reactor.

14. The method of claim 9,
wherein the cylindrical reactor rotates by a rotational force of a driving pulley mounted on an outer surface of the cylindrical reactor, and
the internal rotor has a form in which a driving pulley is further mounted on the common shaft, and the internal rotor rotates by a rotational force of the driving pulley mounted on the common shaft.

15. The method of claim 9,
wherein each of the external walls of the both end portions, the first internal wall, the second internal wall, the third internal wall, and the fourth internal wall included in the cylindrical reactor is made of a transparent plastic material, and
the circumference of each of the external walls of the both end portions, the second internal wall, and the third internal wall is sealed by an O-ring made of an elastic material.

16. The method of claim 15, wherein the transparent plastic material is at least one selected from polypropylene (PP), polyethylene terephthalate (PET), and polymethyl methacrylate (PMMA), and the O-ring made of an elastic material is a fluoroelastomer O-ring.

17. The method of claim 12, further comprising: c) adjusting the rotational speed of the cylindrical reactor and the rotational speed of the internal rotor to be the same, and sampling the aqueous acceptor phase containing the specific metal through the inlet port at the other end portion of the common shaft.

18. A reaction system for selectively separating a specific metal from a leach solution containing a metal mixture using a rotary reactor,
wherein in the reactor which is rotating, an aqueous feed phase which contains the leach solution containing the metal mixture, an organic phase which includes one or more organic extractants for selectively extracting the specific metal from the aqueous feed phase and is formed adjacent to the aqueous feed phase, and an aqueous acceptor phase which is formed adjacent to the organic phase are formed in the form of concentric layers, respectively,
the specific metal in the aqueous feed phase is transferred to the aqueous acceptor phase by the organic extractant included in the organic phase and acting as a molecular shuttle between an aqueous feed phase/organic phase interface and an organic phase/aqueous acceptor phase interface,
the aqueous acceptor phase has a higher density than the organic phase,
the aqueous feed phase and the aqueous acceptor phase are not formed adjacent to each other, and
the aqueous feed phase has a higher pH than the aqueous acceptor phase.

19. The reaction system of claim 18,
wherein the rotary reactor includes: a cylindrical reactor; and a drive unit which rotates the cylindrical reactor,
in the cylindrical reactor which is rotating, the aqueous acceptor phase, the organic phase, and the aqueous feed phase are formed sequentially and adjacently in the order adjacent to or close to an inner side surface of the cylindrical reactor by a centrifugal force due to rotation of the cylindrical reactor,
the aqueous acceptor phase has a higher density than the organic phase,
the organic phase has a higher density than the aqueous feed phase, and
a rotational speed of the cylindrical reactor is periodically accelerated and decelerated.

20. The reaction system of claim 18,
wherein the rotary reactor includes a cylindrical reactor; and an internal rotor provided with a common shaft which passes through center holes of external walls at both end portions of the cylindrical reactor,
as a first internal wall, a second internal wall, a third internal wall, and a fourth internal wall are sequentially arranged in a direction from one end portion of the both end portions toward the other end portion within the cylindrical reactor, a first segment between the external wall at one end portion and the first internal wall; a second segment between the first internal wall and the second internal wall; a third segment between the second internal wall and the third internal wall; a fourth segment between the third internal wall and the fourth internal wall; and a fifth segment between the fourth internal wall and the external wall at the other end portion are provided,
each of the first internal wall, the second internal wall, the third internal wall, and the fourth internal wall has a center hole through which the common shaft passes, each of the second internal wall and the third internal wall has holes at one radial position, and each of the first internal wall and the fourth internal wall has holes at each of two distinct radial positions,
the internal rotor has a form in which two propellers and one impeller are mounted on the common shaft, the two propellers are placed within the first segment and the fifth segment, respectively, and the one impeller is placed within the third segment,
within the first segment and the second segment, the aqueous feed phase and the organic phase are formed sequentially and adjacently in the order adjacent to an inner side surface of the cylindrical reactor by a centrifugal force due to rotation of the cylindrical reactor,
within the third segment, the organic phase is formed adjacent to an inner side surface of the cylindrical reactor by a centrifugal force due to rotation of the cylindrical reactor,
within the fourth segment and the fifth segment, the aqueous acceptor phase and the organic phase are formed sequentially and adjacently in the order adjacent to an inner side surface of the cylindrical reactor by a centrifugal force due to rotation of the cylindrical reactor,
the aqueous feed phase and the aqueous acceptor phase have higher densities than the organic phase, and
a rotational speed (ω₀) of the cylindrical reactor is adjusted to be higher than a rotational speed (ω₁) of the internal rotor.
